(19) United States
(12) Patent Application Publication
(10) Pub. No.: US 2012/0124910 A1
(43) Pub. Date: May 24, 2012

(54) ADJUSTABLE SLIDER FOR A WINDOW REGULATOR SYSTEM, AND VEHICLE STRUCTURE WITH A WINDOW REGULATOR

(76) Inventor: Gabriel Hazon, Sully sur Loire (FR)

(21) Appl. No.: 13/271,846

(22) Filed: Oct. 12, 2011

(30) Foreign Application Priority Data
Oct. 13, 2010 (DE) 10 2010 048 330.3

(51) Int. Cl. E05F 11/40; E05D 15/22

(52) U.S. Cl. 49/350; 16/94 R

(57) ABSTRACT

The invention relates to a slider for a window regulator, having a base element adapted to be connected to a window regulator rail, a holding element adapted to engage at a window pane, and an adjustment mechanism allowing to adjust the inclination of the holding element with respect to the base element, the adjustment mechanism having an adjustment screw which is arranged on the holding element, and a lever operable by the adjustment screw and effective between the base element and the holding element for adjusting the orientation of the holding element with respect to the base element. The invention further relates to a vehicle structure having a window regulator with a window regulator rail and a slider, the slider being mounted at the window regulator rail and a window pane being mounted at the holding element of the slider.

### CROSS REFERENCE TO RELATED APPLICATIONS

This application claims the benefit under 35 U.S.C. §119 of German Patent Application No. 10 2010 048 330.3 filed on Oct. 13, 2010, the contents of which are incorporated herein by reference thereto.

### BACKGROUND

The invention relates to a slider for a window regulator, having a base element adapted to be connected to a window regulator rail, a holding element adapted to engage at a window pane, and an adjustment mechanism allowing to adjust the inclination of the holding element with respect to the base element. The invention further relates to a vehicle structure having a window regulator with a window regulator rail, a slider and a window pane, the window regulator mainly allowing to displace the window pane along the z or vertical axis of the vehicle, and guiding it against loads acting on the window pane in the y direction of the vehicle.

For many vehicle types, no frames for guiding the window pane are used. Rather, the window pane is guided by the window regulator, in particular by means of the slider mounted at the window regulator rail so as to ensure that the window pane is pressed against associated seals when being in an upper, closed position. Due to construction tolerances between the door and the vehicle roof on which the seals are installed, a problem with these window regulators is that the orientation of the window pane must be adjusted after the window regulator together with the window pane is mounted in the vehicle structure. In order to allow an adjustment of the window pane, the holding element of the slider is arranged so as to be pivotable with respect to the base element around an axis which is essentially horizontal in the vehicle length, called the x axis. This allows to adjust the orientation of the window pane and to adjust the position of the window pane in order to make sure that the upper edge thereof correctly engages the associated seal when approaching the upper, closed position.

Another way of adjusting the window pane is to use an adjustment screw at the lower end of the window regulator rail, which determines the orientation of the window regulator rail with respect to the vehicle structure. For example the adjustment screw can be actuated through a hole in the interior trim of the vehicle in order to adjust the position of the window pane. However, an operator can hardly simultaneously turn the screw at the lower end of the window regulator and see the upper edge of the window regulator rail. Accordingly, a couple of adjustment attempts are usually necessary until the window pane is in the proper position. Also, it is not desired to have holes in the door for aesthetic reasons and due to the risk of moisture ingress from the window regulator area which is exposed to rain penetration towards the passenger cell.

The object of the invention is to provide a slider and a vehicle structure with a window regulator rail, which can be adjusted very efficiently and which is of a compact structure so as to require less space.

### SUMMARY

In order to solve the subject, the invention provides in a slider of the type mentioned above that the adjustment mechanism has an adjustment screw which is arranged on the holding element, and a lever operable by the adjustment screw and effective between the base element and the holding element for adjusting the orientation of the holding element with respect to the base element. Providing the adjustment screw on the holder allows to access the adjustment screw from the outside of the vehicle, through the gap through which the window pane extends out of the vehicle structure, after having removed the sealing strip which typically is provided there. Accordingly, an operator can actuate the adjustment screw and simultaneously see the change of the position of the upper edge of the window pane as a result of the adjustment screw being actuated. The lever which is effective between the base element and the holding element results in a very compact structure by means of which the movement of the adjustment screw can be transformed into a pivotal movement of the holding element with respect to the base element.

Preferably, the adjustment screw engages a nut which in turn engages the lever. This mechanism allows to transform a rotational movement of the adjustment screw into a translational movement in a very compact manner.

Preferably, the lever is pivotally held in the nut. This embodiment allows to transform the displacement of the nut into an operating movement of the lever in a very effective manner.

Preferably, the lever is accommodated in a recess in the nut. The recess allows to mount the lever at the nut in a very simple manner.

Preferably, the lever is pivotally held at the base element. This allows to very effectively translate an actuation of the lever into a pivotal movement of the holding element with respect to the base element.

According to a preferred embodiment, the lever is formed as a crank lever with two legs connected to the base element, and a middle section connected to the holding element which can be actuated. A high mechanical stability results from this design.

In order to simplify the mounting process of the slider, the two legs of the lever are facing in the same direction.

Preferably, the lever is connected to the holding element by means of a sliding guide. The sliding guide directly takes up the forces exerted by the lever so that the adjustment screw is not biased in a transverse direction.

A very compact design is achieved by holding the nut non-rotatably between two projections on the holding element which together form the sliding guide.

The adjustment screw can be very efficiently mounted in a stop at the holding element so as to be rotatable but fixed in an axial direction. Preferably, a circlip engages into a groove of the screw so as to fix the adjustment screw.

According to a preferred embodiment, the holding element is attached to a bending portion formed integrally with the base element. This design very efficiently forms the pivot axis around which the holding element can be pivoted with respect to the base element, without requiring any bearings.

Preferably, at least one attachment screw is provided which extends through the holding element so as to be able to clamp the window pane, and which engages the bending portion of the base element. In other words, the attachment screw serves two functions, namely holding the window pane at the holding element and attaching the holding element at the base element.

In order to solve the above mentioned object, the invention provides a vehicle structure having a window regulator with a window regulator rail and a slider of the type mentioned above, the slider being mounted at the window regulator rail and a window pane being mounted at the holding element of the slider, the window pane extending out of the vehicle structure through a gap provided with a seal, the adjustment screw of the slider being arranged adjacent the gap where the slider is at an upward end position at the window regulator rail or close to said end position. Regarding the advantages of this structure, reference is made to the above comments.

### BRIEF DESCRIPTION OF THE DRAWINGS

The invention will now be described with reference to an embodiment which is shown in the drawings. In the drawings:

FIG. 1 schematically shows a vehicle structure with a window regulator according to the invention,

FIG. 2 shows a first perspective view of the slider,

FIG. 3 shows a second perspective view of the slider,

FIG. 4 shows third perspective view of the slider,

FIG. 5 shows a perspective view of the base element, and

FIG. 6 shows a rear view of the holding element.

### DETAILED DESCRIPTION

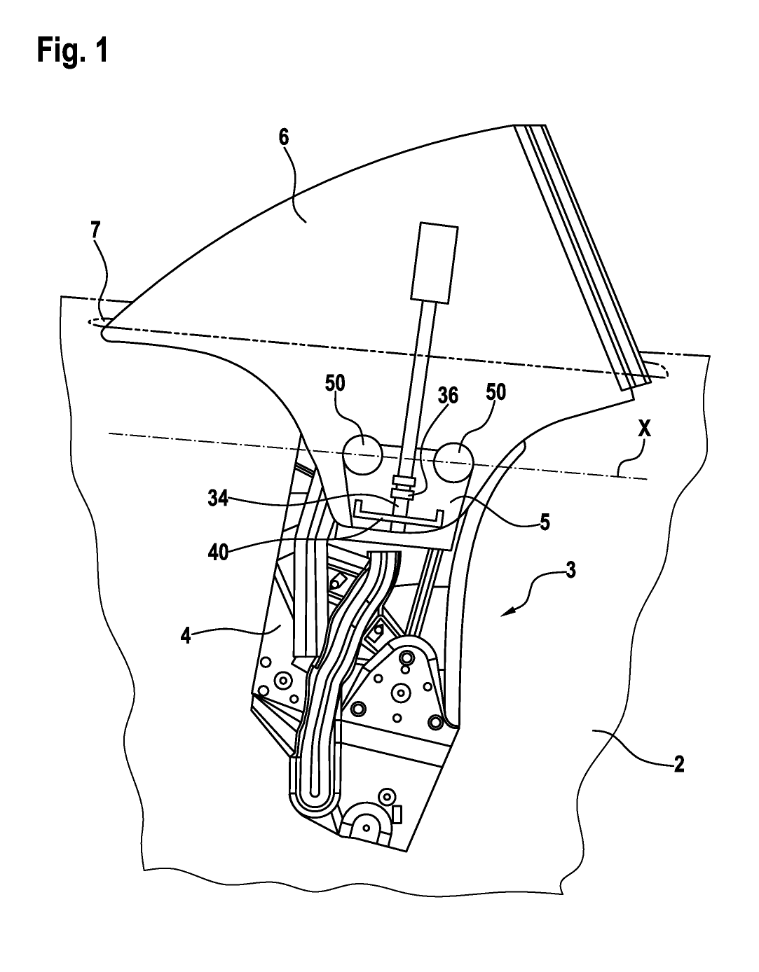

FIG. 1 schematically shows a vehicle structure 2 which is part of the vehicle body and which is provided with a window regulator 3 having a window regulator rail 4 and a slider 5 which is shown here very schematically.

Connected to slider 5 is a window pane 6 which can be displaced from the window regulator in an essentially vertical direction between a closed position which is shown in FIG. 1 and in an open position in which the window pane lies in the interior of the vehicle structure. A gap 7 is schematically depicted here through which the window pane 6 extends out of the vehicle structure and at which a sealing strip is usually attached.

As can be seen in FIG. 1, window pane 6 is not guided by a frame provided on the vehicle structure. Rather, window pane 6 is completely guided by slider 5 which is mounted at window regulator rail 4. In order to make sure that the upper edge of window pane 6 comes to correctly lie in associated seals (not shown) at e.g. the vehicle roof, the orientation of window pane 6 with respect to window regulator 4 can be adjusted. In particular, window pane 6 can be slightly rotated around a pivot axis x shown in FIG. 1 which allows to displace the upper edge of window pane 6 in the y direction of the vehicle, meaning inwardly or outwardly.

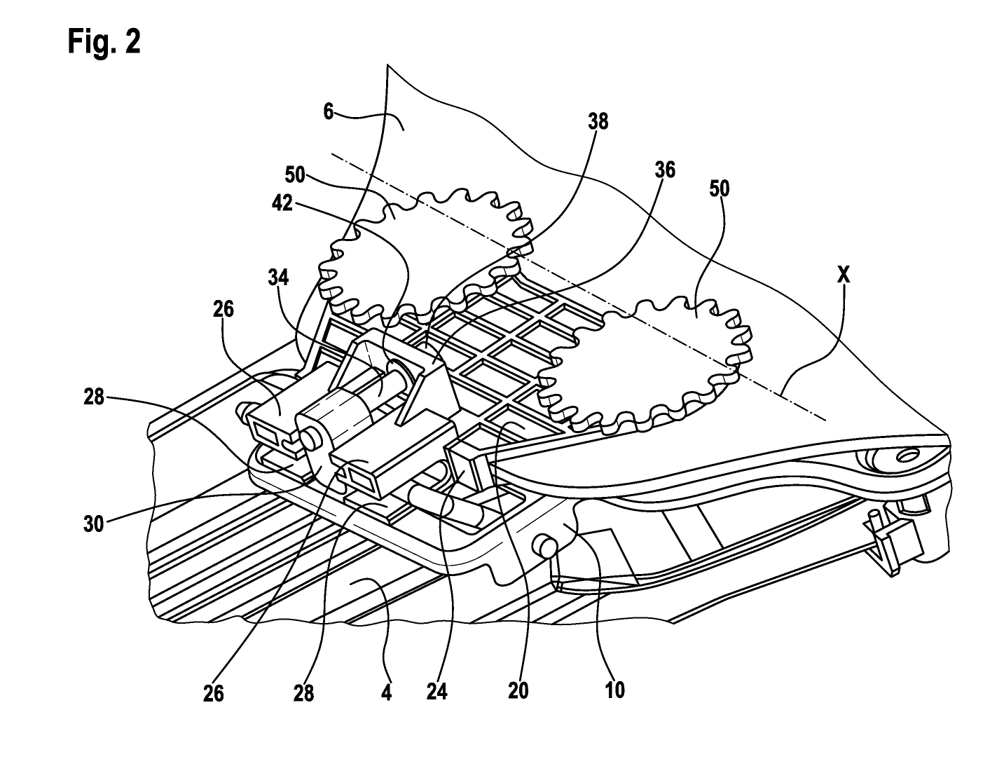

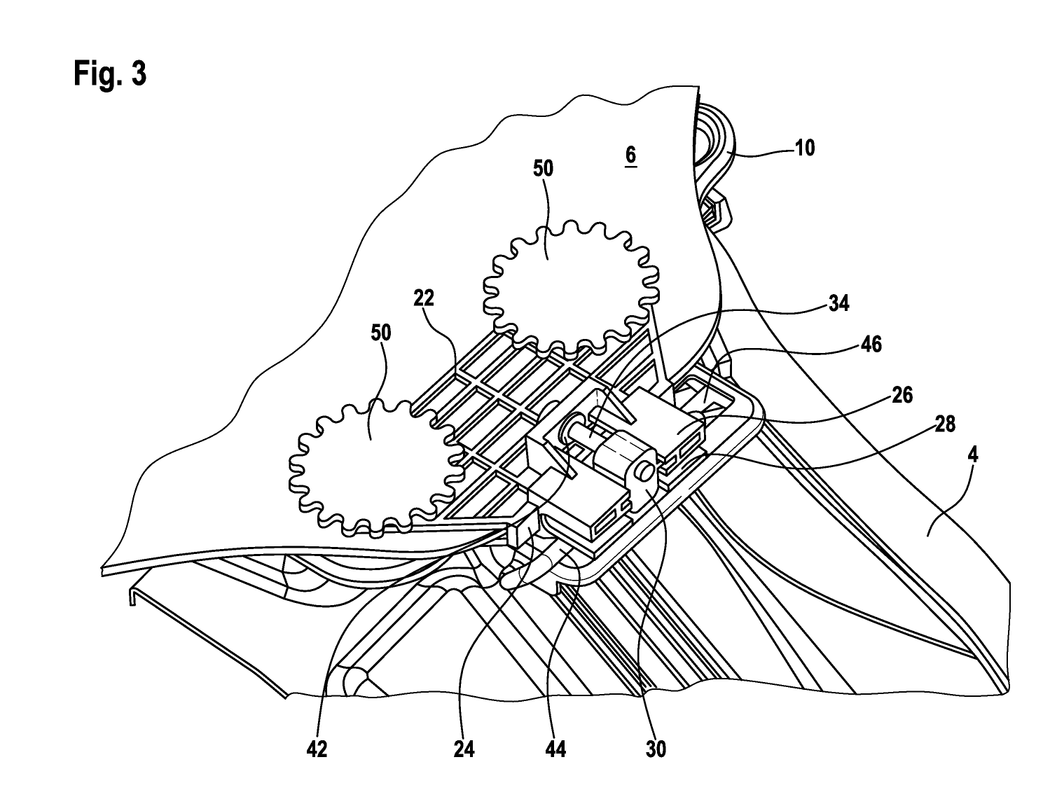

Slider 5 which connects window pane 6 to window regulator 3 comprises a base element 10 (please see FIGS. 2 to 5) which engages at window regulator rail 4, and a holding element 20 which accommodates window pane 6 and which is mounted at base element 10. Base element 10 is formed from sheet metal and comprises two bending portions 12 which are each defined by U-shaped slots 14.

The transition from bending portions 12 to the body of the base element forms a bending axis x which corresponds to pivot axis x. Each bending portion 12 is provided with an attachment opening 15 and a positioning opening 16. At its side opposite to its bending axis x, base element 10 is provided with two openings 17 for a lever 40 and a cut-out 18 which will be explained later.

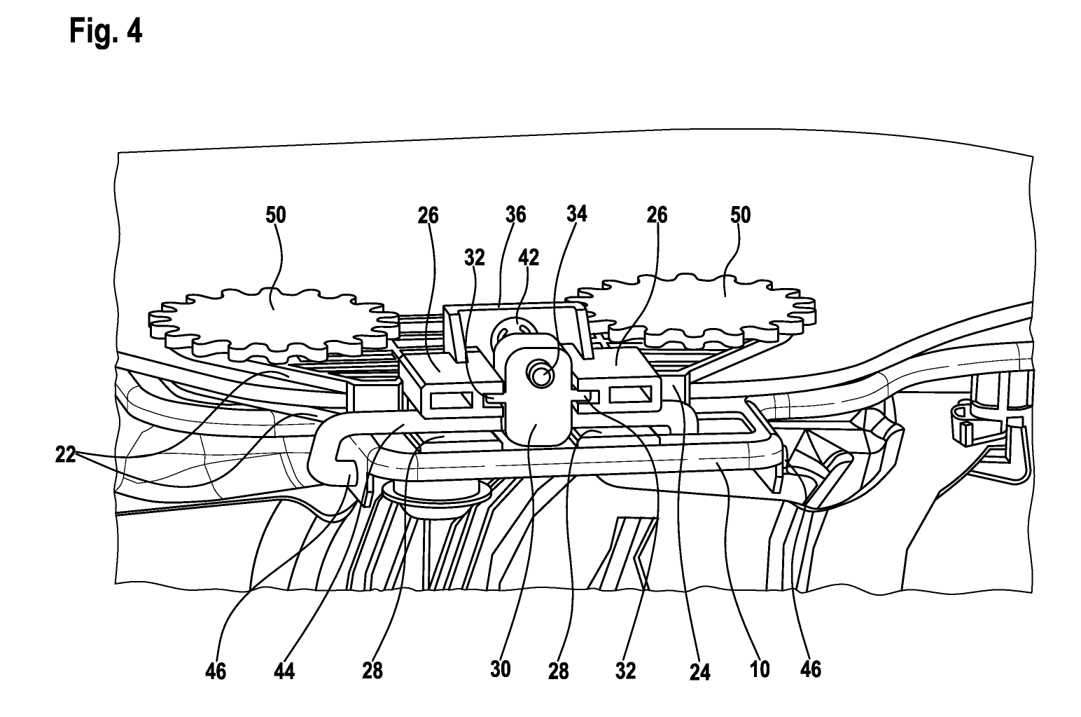

Holding element 20 is made from plastic and comprises two clamping portions 22 between which the window pane is arranged (see in particular FIG. 4) and which are joined to each other by means of a connecting piece 24. At the side which is opposite to the clamping portions 22, connecting piece 24 is provided with two sliding posts 26 which are each provided with a slot 28. Slot 28 accommodates lever 40. The sliding posts 26 are arranged at a distance from each other. Between the two sliding posts, a nut 30 is arranged which is provided with guiding flaps 32 accommodated in grooves in both sliding posts 26. An adjustment screw 34 is threaded into nut 30, with adjustment screw 34 being held at a stop 36 provided on holding element 20. Adjustment screw 34 has a screw head 38 which is arranged on “upper” side of stop 36, while a circlip 42 is arranged “underneath” stop 36. Accordingly, adjustment screw 34 is fixed in an axial direction.

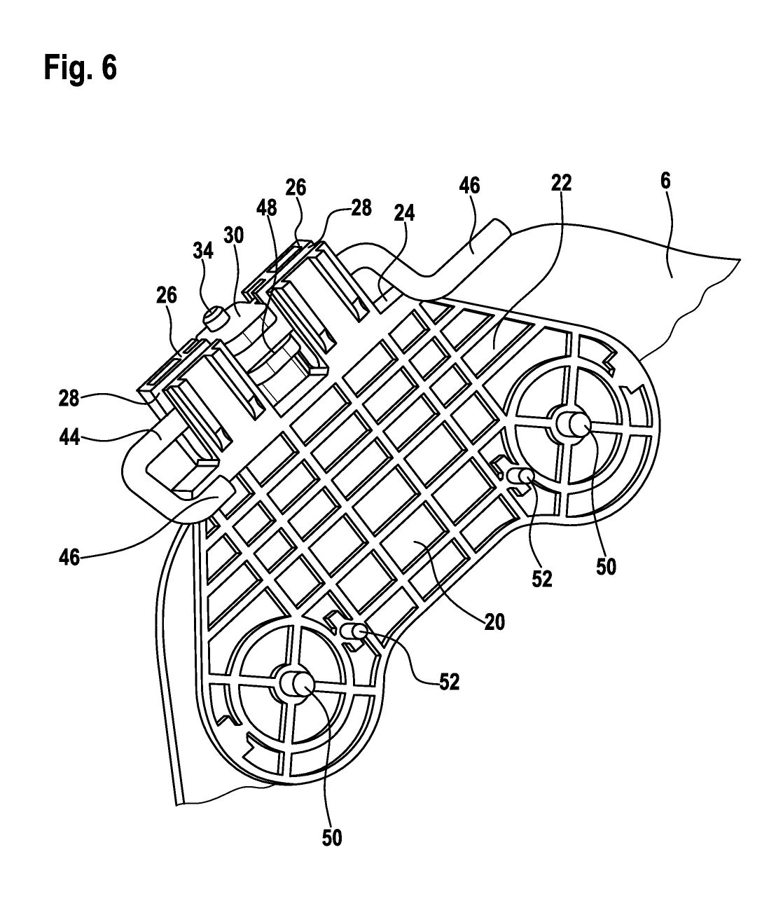

Lever 42 is effective between base element 10 and holding element 20. As can be seen in particular in FIG. 6, lever 40 is formed as a crank lever, namely with a middle section 44 and with two legs 46 with are arranged on either side of middle section 44 and on the same axis. Middle section 44 is arranged at a distance from the axis defined by legs 46. One particularity of the crank lever used here is that both legs 46 face in the same direction, with one of the legs (the right one in FIG. 6) being longer than the other.

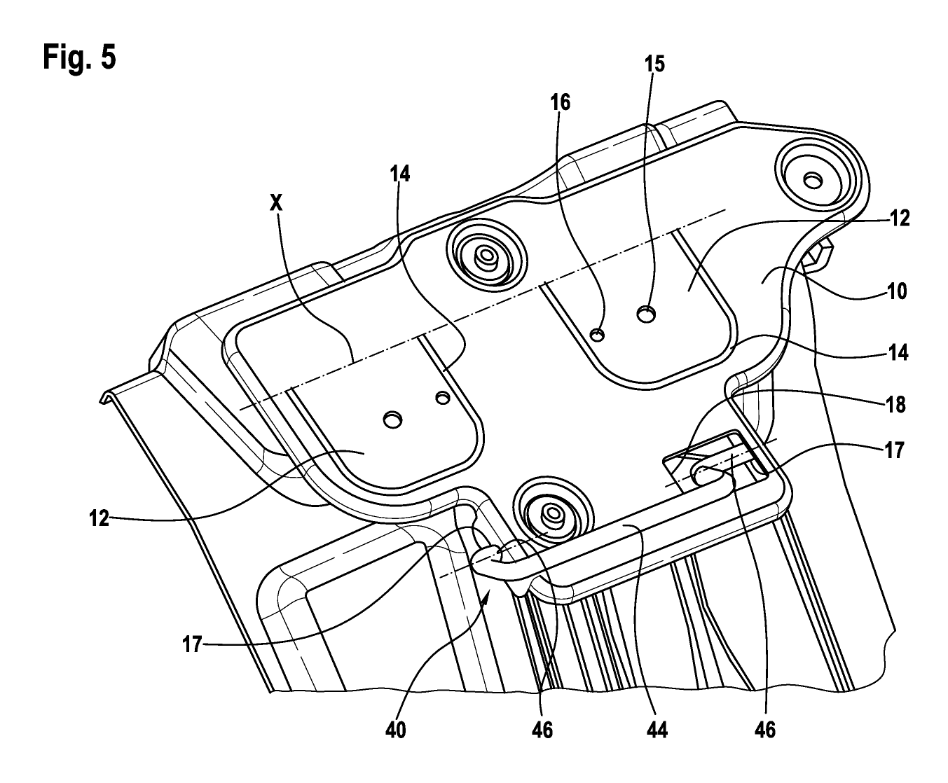

Lever 40 is mounted at the slider such that its two legs 46 engage into openings 17 of base element 10. As can be seen in FIG. 5, lever 40 thereby extends through cut-out 18 such that its legs 46 are arranged underneath the plane defined by the body of base element 10 while middle section 44 is arranged above said plane.

Middle section 44 of lever 40 engages into slots 28 in sliding posts 26 and further engage into a recess 48 provided in nut 30. Accordingly, the end of holding element 20 which is provided with the sliding post 26 is operatively connected to base element 10 via lever 40. Furthermore, holding element 20 is connected to the bending portions 12 of base element 10 by means of screws 50 which engage into attachment openings 15 in bending portions 12. Mounting of the holding element 20 on base element 10 is assisted by positioning posts 52 engaging into positioning openings 16.

Adjustment screw 34 together with nut 30 and lever 40 forms an adjustment mechanism which allows to adjust the orientation of holding element 20 with respect to base element 10. Assuming that adjustment screw 34 is rotated so as to translationally move nut 30 closer to stop 36 (which is towards the right in FIG. 2), this movement of nut 30 will turn lever 40 in a “more upright” position, thereby pushing sliding posts 26 of holding element 20 away from base element 10. Assuming that adjustment screw 34 is rotated so as to move nut away from stop 36, lever 40 is pivoted so as to draw sliding posts 26 towards holding element 10. The respective pivoting movement of holding element 20 with respect to base element 10 occurs around pivot or bending axis x defined by bending portions 12. The maximum displacement of holding element 20 in one direction is limited by nut 30 abutting at holding element 20 at the stop 36, and in the other direction by holding element 20 abutting at base element 10, provided that the stroke of nut 30 rotates the lever 40 of an angle value less than 90° , i.e. the lever is designed such that it is not the limiting component in the adjustment displacement.

Operation of the adjustment mechanism can be done very simply by using a screw driver (schematically depicted in FIG. 1) which engages at head 38 of adjustment screw 34. Preferably, slider 5 is brought into a position in which the upper edge of window pane 6 is very close to the associated seal at for example the vehicle roof. Further, the seal usually associated with gap 7 in the vehicle structure is removed. Thereby, head 38 of adjustment screw is easily accessible so that adjustments screw 34 can be rotated in the desired direction in order to pivot holding element 20 with respect to base element 10, thereby moving the upper edge of window pane 6 in the y direction. Screw 34 being arranged essentially vertically, an operator can conveniently actuate the screw driver and simultaneously visually monitor the position of the window pane with respect to the associated seal. Using a crank lever for controlling the orientation of the holding element with respect to the base element results in a very rigid slider which allows to hold window pane 6 with the required precision.

What is claimed is:

1. A slider for a window regulator, having a base element adapted to be connected to a window regulator rail, a holding element adapted to engage at a window pane, and an adjustment mechanism allowing to adjust the inclination of the holding element with respect to the base element, the adjustment mechanism having an adjustment screw which is arranged on the holding element, and a lever operable by the adjustment screw and effective between the base element and the holding element for adjusting the orientation of the holding element with respect to the base element.

2. The slider of claim 1 wherein the adjustment screw engages a nut which in turn engages the lever.

3. The slider of claim 2 wherein the lever is pivotally held in the nut.

4. The slider of claim 3 wherein the lever is accommodated in a recess in the nut.

5. The slider of claim 1 wherein the lever is pivotally held at the base element.

6. The slider of claim 1 wherein the lever is formed as a crank lever with two legs connected to the base element, and a middle section which can be actuated.

7. The slider of claim 6 wherein the two legs are facing in the same direction.

8. The slider of claim 1 wherein the lever is connected to the holding element by means of a sliding guide.

9. The slider of claim 8 wherein the adjustment screw engages a nut which in turn engages the lever and wherein the nut is held non-rotatably between two guiding posts on the holding element which together form the sliding guide.

10. The slider of claim 1 wherein the adjustment screw is mounted in a stop at the holding element so as to be rotatable but fixed in an axial direction, in particular by means of a clip.

11. The slider of claim 1 wherein the holding element is attached to a bending portion formed integrally with the base element.

12. The slider of claim 11 wherein at least one attachment screw is provided which extends through the holding element so as to be able to clamp the window pane, and which engages the bending portion of the base element.

13. The slider of claim 1 wherein the adjustment screw engages a nut which in turn engages the lever and wherein the lever is pivotally held in the nut and wherein the lever is pivotally held at the base element.

14. The slider of claim 13 wherein the lever is accommodated in a recess in the nut.

15. The slider of claim 1 wherein the adjustment screw engages a nut which in turn engages the lever and wherein the lever is pivotally held in the nut and wherein the lever is pivotally held at the base element and wherein the lever is formed as a crank lever with two legs connected to the base element, and a middle section which can be actuated.

16. The slider of claim 15 wherein the two legs are facing in the same direction.

17. The slider of claim 13 wherein the lever is connected to the holding element by means of a sliding guide.

18. The slider of claim 1 wherein the adjustment screw engages a nut which in turn engages the lever and wherein the nut is held non-rotatably between two guiding posts on the holding element which together form the sliding guide and wherein the adjustment screw is mounted in a stop at the holding element so as to be rotatable but fixed in an axial direction, in particular by means of a clip and wherein the holding element is attached to a bending portion formed integrally with the base element.

19. A vehicle structure having a window regulator with a window regulator rail and a slider for the window regulator, the slider having a base element adapted to be connected to the window regulator rail, a holding element adapted to engage a window pane, and an adjustment mechanism allowing to adjust the inclination of the holding element with respect to the base element, the adjustment mechanism having an adjustment screw which is arranged on the holding element, and a lever operable by the adjustment screw and effective between the base element and the holding element for adjusting the orientation of the holding element with respect to the base element, wherein, the slider is mounted at the window regulator rail and the window pane being mounted at the holding element of the slider, the window pane extending out of the vehicle structure through a gap provided with a seal, the adjustment screw of the slider being arranged adjacent the gap when the slider is at an upper end position at the window regulator rail or close to said end position.

20. The vehicle structure of claim 19 wherein the adjustment screw extends in a generally vertical direction, with the screw head being arranged at the upper end of the screw.
